(19) United States
(12) Patent Application Publication
(10) Pub. No.: US 2004/0052311 A1
(43) Pub. Date: Mar. 18, 2004

(54) Controlled handling of far end at equipment failure in an msp‘unidirectional configuration

(76) Inventors: Magne Sigbjorn Stormo, Grimstad (NO); Olaf Brovoll, Arendal (NO)

Correspondence Address: ERICSSON INC., 6300 LEGACY DRIVE, M/S EVW2-C-2, PLANO, TX, 75024, US

(21) Appl. No.: 10/250,405

(22) PCT Filed: Dec. 27, 2001
(86) PCT No.: PCT/NO01/00510

(30) Foreign Application Priority Data
Dec. 29, 2000 (NO) 20006691

(51) Int. Cl. H04L 25/34

(52) U.S. Cl. 375/288

(57) ABSTRACT

A section near-end equipment (1) in a SDH or SONET system is equipped with a section near-end telecommunication equipment monitor (2) capable of detecting section near-end telecommunication equipment (3) faults. An alarm output (4) of the monitor has a connection (5) to an input (6) of a MS-AIS generator (7) of the section near-end, and effects sending of MS-AIS to a section far-end (8) when the monitor detects a near-end telecommunication equipment fault.

### TECHNICAL FIELD OF THE INVENTION

The invention relates to the field of systems terminating Synchronous Digital Hierarchy/Synchronous Optical Network SDH/SONET signals and more particularly to a method and an arrangement in a multiplex section (MS) of such a system where network protection (redundancy on network termination) is applied.

### BACKGROUND OF THE INVENTION

Systems terminating SDH/SONET signals are typically network elements (NE) in a SDH/SONET network as “Add/drop-multiplexer (ADM), Digital cross-connector (DXC), Terminal multiplexer (TM)” and similar.

An aspect of such systems is the handling of the far end in an MSP (Multiplex section protection) 1+1 single-ended, permanently bridged system when a local or near end terminal detects hardware (HW) and/or equipment failure. An MSP1+1 unidirectional, single-ended system according to ITU-T G.841 (10/98) is illustrated in FIG. 1 of the accompanying drawings.

Referring to FIG. 1, a bridge distributes the protected traffic and/or payload to both physical lines (including both active (A) and standby (P) Multiplex sections). A selector selects the traffic from one of the incoming links. This means that there may be one active (A), and one passive (P) link used by the selector for the incoming traffic. For the outgoing traffic, both links may transmit the same payload due to the bridging.

The MSP 1+1 algorithm is controlled only by the transmission defects/failures (e.g. Multiplex Section Overhead: LOS, LOF, MS-AIS, MS-DEG) at near end, That is only transmission defects in the incoming traffic at each end is considered in a unidirectional, single ended protection protocol. The far end handles its selector independently of the selector at near end. This can lead to a situation where both links are active, but for different directions. This is in accordance with ITU-T G.783(04/97) Annex.A, G.841(10/98) and ETSI ETS 300 417(11/98).

If the equipment at the far end fails (due to hardware faults, power faults, clock synchronisation failure, etc.) this can be handled as a network protection switch (MSP) at near end, if incoming signal is disturbed or lost.

In some cases the equipment may be reported as faulty even if it is able to transport a valid Multiplex Section to the far end. (Multiplex Section protection, as named in ITU-T for SDH networks, protects the traffic carried by the MS. Example VC-4 and VC-12).

If we consider a case where the equipment at near end is reported as faulty but is still able to generate a valid STM-1 frame with valid MS overhead, this means that the far end may select the traffic coming from the link with the faulty equipment (near end). This is due to only MS overhead in the incoming bit-stream being considered for the protection function (no APS channel signalling is used for unidirectional protection). So, in this case the traffic transmitted from the near end by faulty equipment may have a valid MS but corrupted data (VC4, VC12, etc.) due to the equipment fault, but the far end does not detect this when the applied protection protocol only considers the multiplex section overhead received.

Consequently, traffic may be lost even in a protected system when the Hardware/equipment fault in one end is not communicated to the other end.

Known Solutions and Problems with these Solutions

In the following description ETSI terminology is being used, but the principles will be valid also for ANSI and TTC standards as well.

ITU-T Q.542 (03/93) table 1 recommends for unprotected PDH systems that AIS be sent towards the far end or the switch (i.e. in both directions) at failure of power supply, provided that this is possible.

Another possibility is to use a bi-directional protection switching protocol, such as e.g. MSP1:1. This means that an STM-1 embedded control channel (APS channel) is used to co-ordinate the switching activities at local and far end. In this solution both ends will use the same physical link for receiving traffic. However, a bi-directional protection scheme is more complex due to use of the APS channel, which requires the handshaking between both ends at every switch-related action.

The user manual for Cisco 7500 and Cisco 12000, “Automatic Protection Switching of Packet-over-SONET Circuits” 25 September, 1998, discloses equipment capable of sending an alarm indication signal (AIS) to force a protection switching when the system is set to a state referred to as “administrative shut-down state”. In the context of the invention, an “administrative state” must be understood as a state, which only can be changed by an operator. Thus, a defective network interface or network element, will not automatically change the system state to an “administrative shut-down state” before an operator arrives and manually sets the system to this particular state. The disclosure does, on the other hand, state that the condition that changes in case of an equipment fault is referred to as an “operational state”, but does not include an indication of any function, which will lead to sending of an AIS signal from the equipment covered by the disclosure. Further details regarding the meaning of the term “administrative shut-down state” is found in a further document provided by Cisco, available at the Cisco website. (URL: http://www.cisco.com/univercd/cc/td/doc/product/rtrmgmt/ugm/usguide/ugmcas.htm)

Tektronix technical dictionary, “Synchronous Optical Network (SONET) Tutorial” available through the Internet reference on the IEC website (http://www.iec.org/tutorials/sonet/glossary.htm), repeatedly states that AIS is a signal defined always to be sent “down-stream”, which is different from sending an AIS towards the “far end”. In this context, the telecommunication standard document G.707 (03/96), section 6.2.4.1., “Alarm Indication Signals”, provides the following: “The alarm indication signal (AIS) is a signal sent down-stream as an indication that an up-stream defect has been detected”. Tektronix, also gives a similar definition of a direction with regard to sending of the AIS signal, in the aforementioned document.

MainStreetExpress 36170 by Alcatel, section 44.2, “Major Alarm descriptions”, issue 2, June 2000, provides an overview of major alarms of the MSX 36170. In particular, with regard to the description of the AIS, by reading the definitions and accompanying descriptions, an operator is provided guidance with respect to the nature of an equipment fault, which may have led to an AIS alarm being generated. The description provided does, however, not provide the reader with any clue as to the technical features of the respective equipment that may have generated such an AIS alarm, nor describes any features with respect to equipment that may have received an AIS alarm signal.

Known solutions do not offer a satisfactory solution when using single-ended, unidirectional protection switching protocol. Sending of MS-AIS as recommended by ITU-T Q.542 is, as mentioned, recommended for PDH systems, and covers only power supply failures. Other fault cases such as when an on-board processor does not respond, synchronisation fails and is reported as equipment failure, etc., have not been considered, and there is a need to provide a solution to handle such situations.

The inventors of the present invention have found, that the only existing solution is the above-mentioned use of the more complex protocol named MSP1:1 bi-directional protection switching. As mentioned above, this implies use of the embedded APS channel in accordance with the standards/recommendations, which cannot be applied in a unidirectional protocol based system where the near end and the far end are independent of each other with respect to selecting which link to receive traffic from.

It would therefore be desirable to provide an improved solution for equipment fault handling in an MSP1+1 (Multiplex section protection) single-ended, permanently bridged system.

### BRIEF SUMMARY OF THE INVENTION

A section near-end equipment in a SDH or SONET system is equipped with a section near-end telecommunication equipment monitor capable of detecting section near-end telecommunication equipment faults. An alarm output of the monitor has a connection to an input of a MS-AIS generator of the section near-end, and effects sending of MS-AIS to a section far-end when the monitor detects a near-end telecommunication equipment fault.

According with ANSI/ITU-T standards/recommendations, Multiplex Section (ANSI: Line) Alarm Indication Signal is one of the defect indications that will initiate a protection switching. This means, that applying MS-AIS towards the far end on the outgoing link will force the far end to perform a protection switch. If the equipment is reported as faulty, then the equipment reported as faulty will send MS-AIS to far end. This will in term force the far end to perform a protection switch since MS-AIS is one of the defect in indications that triggers MSP1+1 protection switch in such a system.

Further, in a system according to the invention, by combining known elements (from ITU-T Q.542, G.783 A.1 and G.841) a more controlled situation in MSP1+1 single-ended systems is obtained. This is achieved by arranging the equipment (in a protected environment) such that it always will to send MS-AIS (or similar) when the equipment is reported as faulty.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a block diagram illustrating a typical MSP 1+1 unidirectional, single-ended system;

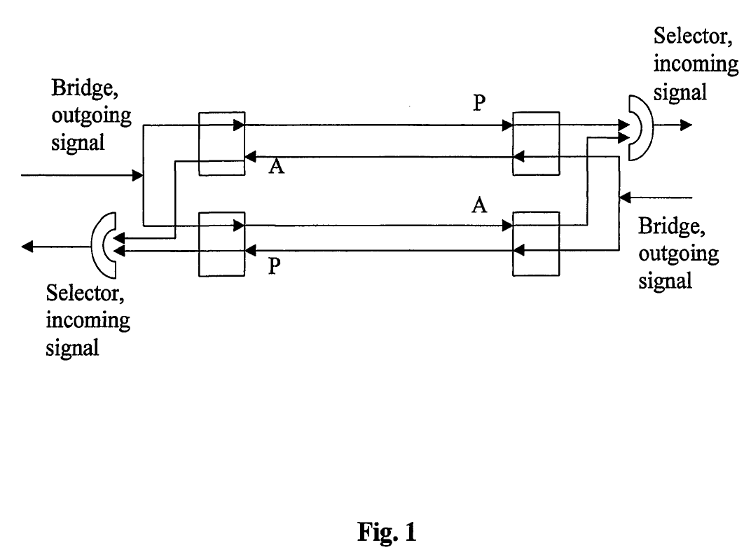

FIG. 2 is a block diagram illustrating a near end equipment fault situation in a system as shown in FIG. 1;

FIG. 3 is a block diagram of line terminating equipment (HW) according to an embodiment of the present invention;

FIG. 4 is a flow chart of actions at detection of a HW fault with a solution according to the invention; and

FIG. 5 is a block diagram illustrating the status of a MSP 1+1 unidirectional, single-ended system during a situation as illustrated in FIG. 2.

### DETAILED DESCRIPTION OF THE INVENTION

The invention will now be explained in more detail, by way of example, and with reference to the accompanying drawings.

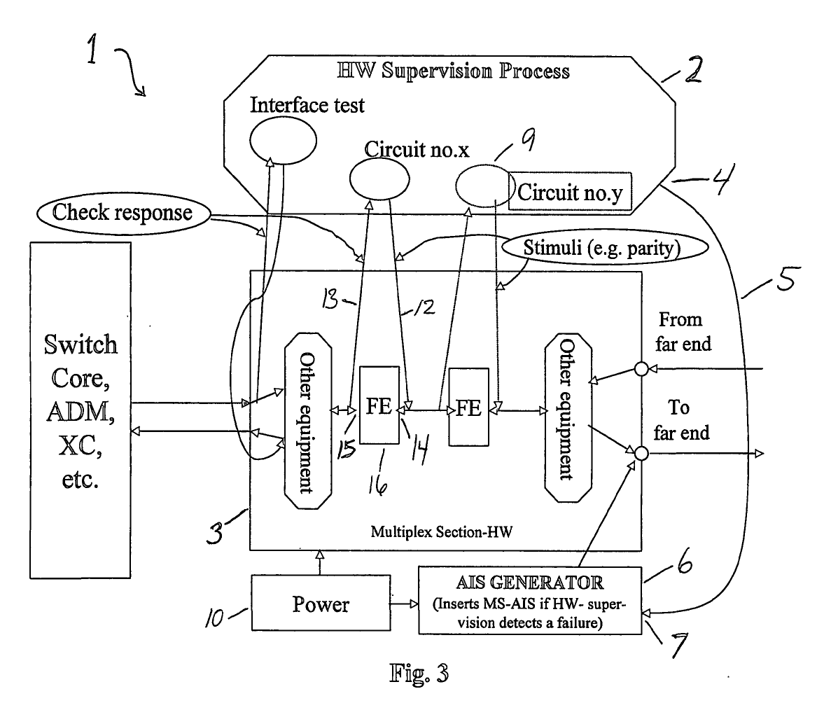

Referring now to FIG. 3, a block diagram of line terminating equipment, the near end of a unidirectional, single-ended, redundancy protected line according to an embodiment of the present invention, is illustrated. It is common that the supervision of the equipment HW 1 is done by periodically checking response, correct bit-patterns at input/output of on-board circuits/chips, or similar in order to detect abnormalities in the equipment. In an embodiment of the invention, software that runs on the processor(s) located at the board itself controls the sending of MS-AIS whenever any equipment fault is reported.

A power supply section (10), near end telecommunication equipment (3), an automatic fault detecting means (2) in communication with an automatic AIS generator (6) is connected to automatically generate an AIS whenever a near end telecommunication equipment (3) exhibits a fault, the power supply (10) faults or a first AIS signal is detected being carried by an incoming telecommunication signal. A test stimuli output (12) connected to a section end equipment hardware (16) and a test response input (13) connected to an output (15) of the section end equipment (16). The HW supervision process (2) is primarily a fault detector. It will be understood that when the fault is detected in the system, which in FIG. 3 is referred to as “from far end”, then the AIS signal is sent towards the element referred to as “switch core”.

The equipment HW supervision process (2) is a function (implemented in hardware or software) that has the main task to supervise the equipment, and can supervise the equipment hardware in several different ways. For instance, there can be inserted a predefined bit pattern at the input ports 14 of circuits at the board, and then monitor at the output port 15 to see if it gives the expected result. If the expected result is not obtained, then the circuit may be classified as faulty. Similarly, there may be a test of signal interfaces at circuit module or circuit board level; i.e. at interfaces between different parts of the system. The supervision process may then use echo-tests, for instance, to monitor whehter the interface is working correctly. One way of doing this is to send a signal, start a timer, and wait for response. If a response is received before the timer expires, then the interface may be considered to be working as intended. If the appropriate response is not obtained, then the board or system may be classified as faulty.

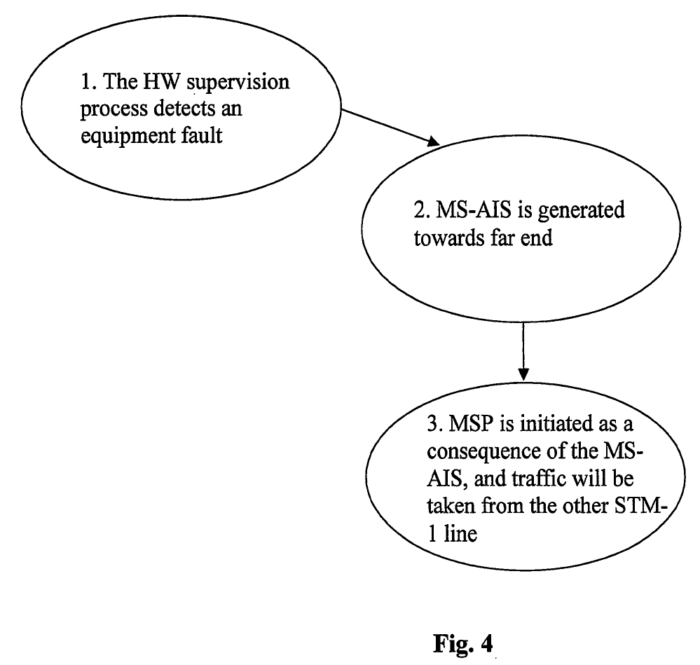

FIG. 4 is a flow chart of actions at the detection of a HW fault according to a preferred embodiment of the present invention. In the first step of the process, the HW supervision process (2) detects an equipment fault and communicates with the AIS generator (6) via interface (7) to insert a MS-AIS towards the far end. In the second step, the MS-AIS is generated and transmitted to the far end (8). This step forces the far end to perform a protection switch. In step 3, multiplex section protection is initiated upon receipt of the MS-AIS and traffic is then taken from the alternate STM-1 line.

As indicated above, a number of ways for declaring a board (or boards) faulty, can be employed and then use this fault declaration as indication to generate MS-AIS at the outgoing STM-1 port towards far end. The far end will then react as if it was a normal protection switch (that is triggered by network faults only, this is according to recommendations/standards, e.g. ITU-T G.841). The result achieved is that we have more control of the network termination—the far end will not use traffic sent from a faulty board.

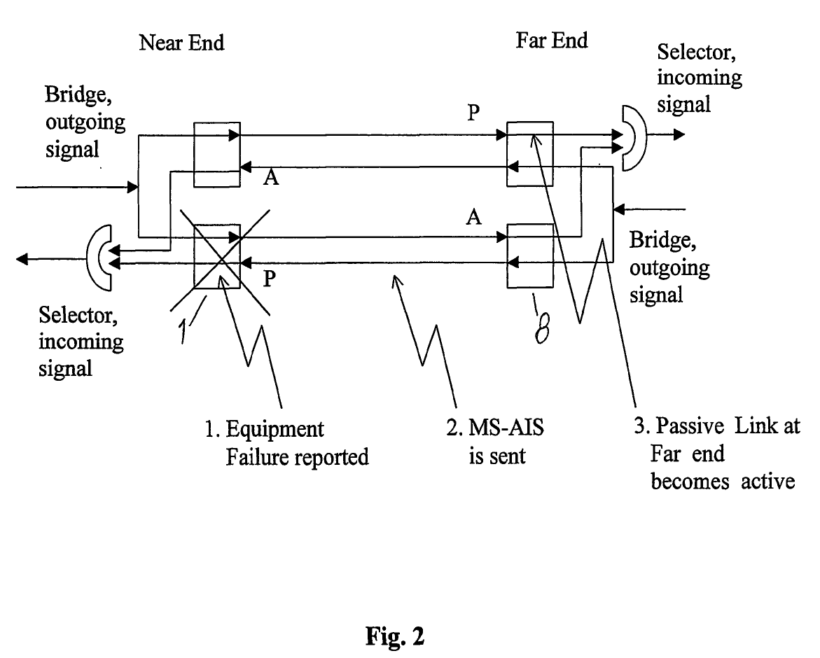

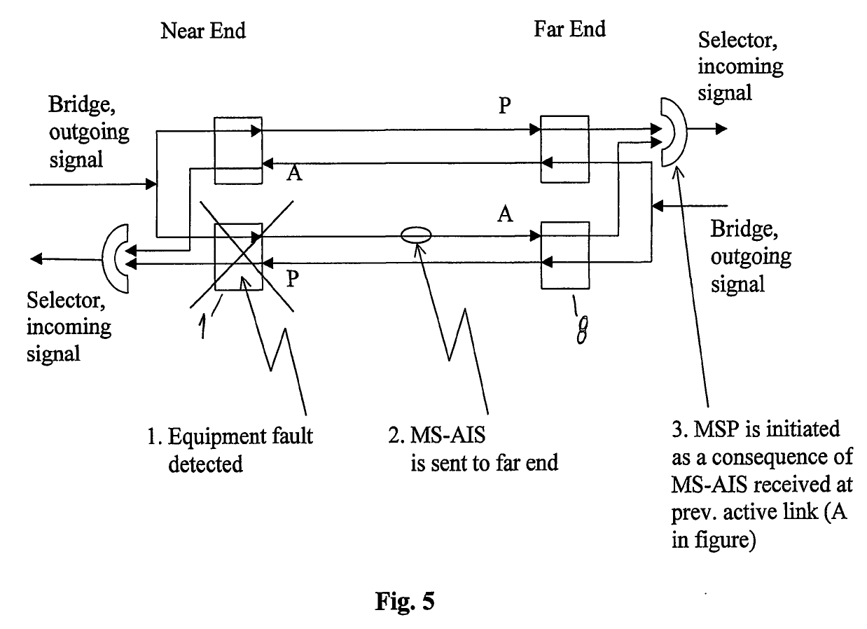

FIG. 5 is a block diagram illustrating the status of a MSP 1+1 unidirectional, single-ended system during a situation as illustrated in FIG. 2.

The generation of MS-AIS can be realised in a number of ways, such as e.g., by hardware or by a software function. The important issue is that MS-AIS is generated upon detection of a HW/equipment fault.

Examples of HW/equipment faults include:

Parity faults;

Too high temperature;

Component fault;

Printed board assembly (PBA) fault;

Impedance problems in input/output ports; and

Failure of circuits terminating interface to other parts of the system (typically detected by echo tests; send signal—wait for answer, if no answer ->declare fault)

Periodic problems. A limit can be defined for how many disturbances are allowed during, for instance, 24 hours. If there are more than 3 HW/Equipment fault indications during 24 hours, we might declare this equipment as too unstable (i.e. we believe it is a periodic HW fault) to be used for traffic. It might have impact on the transported traffic. In this case it may also be declared as “some HW/Equipment fault”.

If or when a HW fault disappears; the HW supervision process will detect this and determine a “no fault” situation has occurred. When the “no-fault” situation occurs, the HW supervision process will order a stop of sending MS-AIS to the far end. This will however not result in a protection switch since the MSP1+1 protocol used here is non-revertive. However, if it was a revertive system, a switch back operation would be performed MS-AIS is realised by inserting all “1”s in the entire STM-1 signal, excluding STM-1 RS over head (according to ITU-T G.707 (03/96) ch.6.2.4.1.1.

The present invention provides a more robust single ended, unidirectional network protection switching protocol defined by ANSI, ITU-T, ETSI and it is possible to avoid losing traffic for specific cases of hardware/equipment faults. Also, the handling of local and far end will be more synchronised and more controlled protection from equipment faults. Further, the present invention can be used for terminations following the ANSI (American National Standardisation Institute), the Japanese (TTC) and the ITU-T/ETSI (International Telecommunication Union/European Telecommunications Standards Institute) Standards/Recommendations. Note that the naming of the contained objects and defects detected for protection purposes differ for the mentioned markets.

In summary, the invention may be used for, and adapted to, systems according to any of the standards/recommendations specified by ITU-T, ANSI or TTC. Accordingly, it may be applicable both for SDH and for SONET standards. Within the SDH and SONET hierarchy, there are also defined different levels of terminations, meaning, for example, for SDH there are defined STM-1 (155 Mbps), STM4 (622 Mbps), STM-16 (2.5 Gbps), etc. In SONET there are correspondingly OC-3 (155 Mbps), OC-12 (622 Mbps), OC48 (2.5 Gbps), etc. However, the invention may be applied to implementations at all levels of SDH/SONET.

### APPENDIX A

Abbreviations

ADM Add Drop Multiplexor

AIS Alarm Indication Signal

ANSI American National Standardisation Institute

APS Automatic Protection Switching

DEG Degraded Defect/failure

ETSI European Telecommunication Standards Institute

HW Hardware

ITU-T International Telecommunication Union—Telecommunications sector

LOF Loss of Frame

LOS Loss Of Signal

MS Multiplex Section

MS-AIS Multiplex Section Alarm Indication Signal

MSP Multiplex Section Protection

PDH Plesiochronous Digital Hierarchy

SDH Synchronous Digital Hierarchy

SDIP Synchronous Digital Path

SONET Synchronous Optical Networks

SNCP Sub-Network Connection Protection

STM-N Synchronous Transport Module level N

TTC Telecommunications Technology Committee (Japan)

VC-n Virtual Container n

XC Cross Connect

Terms and Definitions

Bi-directional operation A protection switching architecture which a protection switch event in one direction automatically generates a corresponding switch in the other direction.

Bridge The action of transmitting identical traffic on both the working and protecting trail.

MSP1+1 Two parallel lines supporting the identical MS-traffic (STM-1), one line protecting the other.

Protection The use of pre-assigned capacity between nodes to replace a failed or degraded transport entity. This means that in case of a transmission fault, the traffic is switched to another transmission path.

Uni-directional operation A protection switching architecture in which, for an uni-directional failure (i.e. a failure affecting only one direction of transmission), only the affected direction is switched to protection.

What is claimed:

1. A signalling method in a unidirectional, single-ended, redundancy protected telecommunication system comprising at least two section far end equipment and two section near end equipment, connected in a multiplexer section fault protecting (MSP) 1+1 configuration, wherein incoming telecommunication signals to each of two section end equipment at one end arriving from corresponding upstream equipment at the opposite end are conveyed to a downstream located fault protection switching means responsive to an alarm indication signal (AIS) carried by at least one of the conveyed telecommunication signals, and wherein at least one of the section end equipment includes an automatic fault detecting means for detecting a fault in the respective section end equipment, or, by echo-testing, in a downstream device, and an AIS generator in communication with the fault detecting means, the method comprising the steps of:
automatically detecting a fault by the fault detecting means and generating an alarm indicator,
triggering the AIS generator by the alarm indicator and generating a first AIS,
communicating the first AIS from the respective equipment to the respective downstream located fault protection switching device,
generating a second AIS on basis of the alarm indicator or on basis of the first AIS, and
communicating the second AIS from the at least one section end equipment of the respective fault detecting means to a corresponding upstream located section far end equipment.

2. A signalling method in a unidirectional, single-ended, redundancy protected telecommunication system comprising at least two section far end equipment and two section near end equipment, connected in a multiplexer section fault protecting (MSP) 1+1 configuration, wherein incoming telecommunication signals to each of two section end equipment at one end arriving from corresponding upstream located equipment at the opposite end are conveyed to a downstream located fault protection switching means responsive to an alarm indication signal (AIS) carried by at least one of the telecommunication signals, and wherein at least one of the section end equipment includes an automatic AIS detecting means for detecting an incoming AIS to a corresponding upstream located equipment and an AIS generator in communication with the AIS detecting means, the method comprising the steps of:
receiving and detecting in the at least one section end equipment a first AIS from a corresponding upstream located section far end equipment,
conveying the first AIS from the at least one section end equipment to the respective downstream located fault protection switching device,
automatically generating a second AIS on basis of the first AIS, and
communicating the second AIS from the at least one section end equipment to the corresponding upstream located section far end equipment.

3. The method of claim 2, further comprising the steps of:
receiving the second AIS by the corresponding upstream located section far end equipment, and
communicating the second AIS from the corresponding upstream located section far end equipment to the respective fault protection switching device of the corresponding upstream located section far end equipment.

4. The method of claim 1, further comprising the steps of:
sending from the at least one section end equipment an echo-test signal to a downstream located telecommunication device and starting a timer,
waiting to receive from the downstream located telecommunication device a response to the echo-test signal, and
generating the alarm indicator if the timer expires before receiving the response.

5. The method of any one of claim 4,
wherein the detected fault is at least one of a parity fault, excessive equipment temperature, an electronic component fault, a printed wiring board assembly fault, an impedance problem in an input port or an output port, a failure of a circuit terminating interface to other system parts, and an intermittent disturbance reoccurring within a predefined time.

6. arrangement in a section end equipment of a unidirectional, single-ended, redundancy protected telecommunication system comprising at least two section far end equipment and two section near end equipment, connected in a multiplexer section fault protecting (MSP) 1+1 configuration, wherein incoming telecommunication signals to each of two section end equipment at one end arriving from corresponding upstream located equipment at the opposite end are conveyed to a downstream located fault protection switching means responsive to an alarm indication signal (AIS) carried by at least one of the telecommunication signals, at least one of said section end equipment comprising a power supply, section end telecommunication equipment, an automatic fault detecting means in communication with an automatic AIS generator arranged to automatically generate an AIS on basis of the detection of a telecommunication equipment fault or power supply fault or on basis of a first AIS signal carried by the incoming telecommunication signal,
wherein the at least one of said section end equipment is arranged to apply the automatically generated AIS to the respective output telecommunication signal being conveyed towards the corresponding upstream located section end equipment.

7. The arrangement of claim 6,
wherein the fault detecting means comprises at least one test stimuli output connected to a section end equipment hardware (HW) input and at least one test response input connected to an output of said section end equipment HW.

8. The arrangement of claim 7, wherein
the fault detecting means is adapted to detect a fault selected from a group comprising:
a parity fault, excessive equipment temperature, an electronic component fault, a printed wiring board assembly fault, an impedance problem in an input port or an output port, a failure of a circuit terminating interface to other system parts, and an intermittent disturbance reoccurring within a predefined time.

9. The method of claim 1, further comprising:
receiving the second AIS by the corresponding upstream located section far end equipment, and
communicating the second AIS from the corresponding upstream located section far end equipment to the respective fault protection switching device of the corresponding upstream located section far end equipment.

10. The method of claim 3, wherein the detected fault is at least one of a parity fault, excessive equipment temperature, an electronic component fault, a printed wiring board assembly fault, an impedance problem in an input port or an output port, a failure of a circuit terminating interface to other system parts, and an intermittent disturbance reoccurring within a predefined time.

11. The method of claim 4, wherein the detected fault is at least one of a parity fault, excessive equipment temperature, an electronic component fault, a printed wiring board assembly fault, an impedance problem in an input port or an output port, a failure of a circuit terminating interface to other system parts, and an intermittent disturbance reoccurring within a predefined time.
